(19) United States
(12) Patent Application Publication
(10) Pub. No.: US 2012/0109994 A1
(43) Pub. Date: May 3, 2012

(54) ROBUST AUTO-CORRECTION FOR DATA RETRIEVAL

(75) Inventors: Yun-Cheng Ju, Bellevue, WA (US); Frank Liu, Redmond, WA (US); Yen-Tsang Lee, Sammamish, WA (US); Jason Farmer, Redmond, WA (US); Ted E. Dinklocker, Sammamish, WA (US)

(73) Assignee: MICROSOFT CORPORATION, Redmond, WA (US)

(21) Appl. No.: 12/914,882

(22) Filed: Oct. 28, 2010

(51) Int. Cl. G06F 17/30

(52) U.S. Cl. 707/767; 707/E17.016; 707/E17.017

(57) ABSTRACT

A data-retrieval method for use on a portable electronic device. The method comprises receiving a query string at a user interface of the device and displaying one or more index strings on the user interface such that the relative prominence of each index string displayed increases with increasing resemblance of that index string to the query string. The method further comprises displaying an index string with greater prominence when a fixed-length substring of the query string occurs anywhere in the index string, regardless of position. In this manner, the relevance of prominently displayed index strings increases as more characters are appended to the query string, even if the query string contains errors.

### BACKGROUND

In many different scenarios, a user of a portable electronic device may retrieve data via an interface of the device; the interface may oblige the user to enter a search query to identify the data to be retrieved. The user may be a motorist wishing to retrieve driving instructions from a navigation device, for example, or to play a song from the library of a portable music player. In these and other examples, the query may be entered directly as text, or it may be entered in some other form—e.g., handwriting or speech—and then converted to text. Text entry, however, whether direct or indirect, may be inconvenient, tedious, and/or prone to user error. This is true especially when the interface requires precise entry of long or hard-to-remember search queries. Naturally, the user that enters an erroneous search query on such an interface may have difficulty retrieving the desired data, which may cause frustration.

Some user interfaces automatically invoke an auto-correction, auto-completion, or so-called “partial search” method to modify search-query input from a user. However, some such methods rely on extensive network resources and services, making them more applicable to server systems than to portable devices. Other methods may be implemented on portable devices, but are less robust; some may be undone by the initial entry of a single erroneous character.

### SUMMARY

Therefore, one embodiment of this disclosure provides a data-retrieval method suitable for use on a portable electronic device, the device having a user interface and a database where a plurality of data items are indexed each to a corresponding index string The method comprises receiving a query string at the user interface and displaying one or more index strings on the user interface such that the relative prominence of each index string displayed increases with increasing resemblance of that index string to the query string. The method further comprises displaying an index string with greater prominence when a fixed-length substring of the query string occurs anywhere in the index string, regardless of position. In this manner, the relevance of prominently displayed index strings increases as more characters are appended to the query string, even if the query string contains errors.

It will be understood that the summary above is provided to introduce in simplified form a selected part of this disclosure, which is further described hereinafter. It is not meant to identify key or essential features of the claimed subject matter. Rather, the claimed subject matter is defined only by the claims and is not limited to implementations that solve any disadvantages noted herein.

### BRIEF DESCRIPTION OF THE DRAWINGS

FIG. 1 shows aspects of an example data-retrieval environment in accordance with an embodiment of this disclosure.

FIG. 2 shows aspects of an example portable device in accordance with an embodiment of this disclosure.

FIG. 3 shows aspects of an example computer system in accordance with an embodiment of this disclosure.

FIG. 4 illustrates an example method for retrieving data from a database in accordance with an embodiment of this disclosure.

FIG. 5 illustrates an example method for enumerating a set of substrings based on an index string or query string in accordance with an embodiment of this disclosure.

FIG. 6 illustrates an example method for assembling metadata for data items in a database in accordance with an embodiment of this disclosure.

FIG. 7 illustrates an example method for displaying one or more index strings on a user interface such that the relative prominence of each index string displayed increases with increasing resemblance of that index string to a query string, in accordance with an embodiment of this disclosure.

### DETAILED DESCRIPTION

The subject matter of this disclosure is now described by example and with reference to the illustrated embodiments listed above. Components, process steps, and other elements that may be substantially the same in one or more embodiments are identified coordinately and are described with minimal repetition. It will be noted, however, that elements identified coordinately may also differ to some degree. It will be further noted that the drawing figures included in this disclosure are schematic and generally not drawn to scale. Rather, the various drawing scales, aspect ratios, and numbers of components shown in the figures may be purposely distorted to make certain features or relationships easier to see.

FIG. 1 shows aspects of an example data-retrieval environment 10 in one embodiment. FIG. 1 shows user 12 and portable device 14. In the illustrated embodiment, the data-retrieval environment is the interior of a motor vehicle, and the user is a motorist. It will be understood, however, that this disclosure is in no way limited to motor-vehicle applications, as numerous other data-retrieval environments are contemplated as well. Accordingly, the portable device may be a navigation (e.g., global-positioning) system, a portable music player, a motorist-assistance device, a cellular telephone, a hand-held video game, or virtually any other electronic device capable of retrieving data at a user's request.

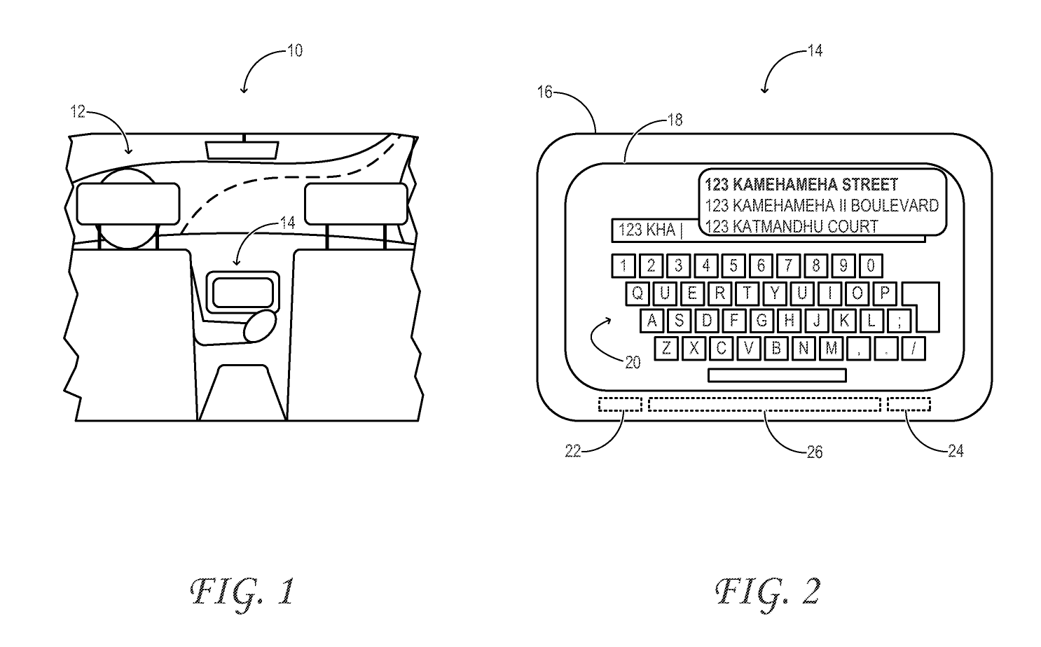

FIG. 2 shows aspects of an example portable device 14 in one embodiment. The portable device presents a user interface 16, which includes display 18. To enable text entry, the user interface also includes keypad 20. In one embodiment, the keypad comprises a set of mechanical key switches. In another embodiment, where the display is a touch-sensitive display, the keypad comprises an touchable image formed on the touch-sensitive display. The keypad illustrated in FIG. 2 includes a separate key for each alphanumeric character used in the English language. In other embodiments, the keypad may include fewer keys, like the keypad of a telephone. Thus, a given key of the keypad may be used to enter a plurality of different characters or character combinations according to a suitable disambiguation rule.

Keypad 20, irrespective of its particular configuration, enables user 12 to enter text in the form of a character string—i.e., a sequence of characters. The characters of the character string may include alphanumeric characters (e.g., 0 through 9 and A through Z) in addition to punctuation characters and control characters, such as a line-feed character. In one embodiment, the characters forming a character string may be coded according to the ASCII standard, while other standards are equally contemplated. Throughout this disclosure, the terms “string” and “character string” are used interchangeably. “Query string” refers to a character string provided as input to specify an item to be retrieved from a database. “Index string” refers to a character string included in a database and used to index a particular data item therein.

Continuing in FIG. 2, user interface 16 also includes microphone 22. The microphone is a transducer configured to receive audible speech from user 12 and to transform the audible speech into an electrical signal. Likewise, the user interface includes loudspeaker 24, a transducer configured to receive an electrical signal and generate sound audible to the user. Such sound may include speech or music, for example.

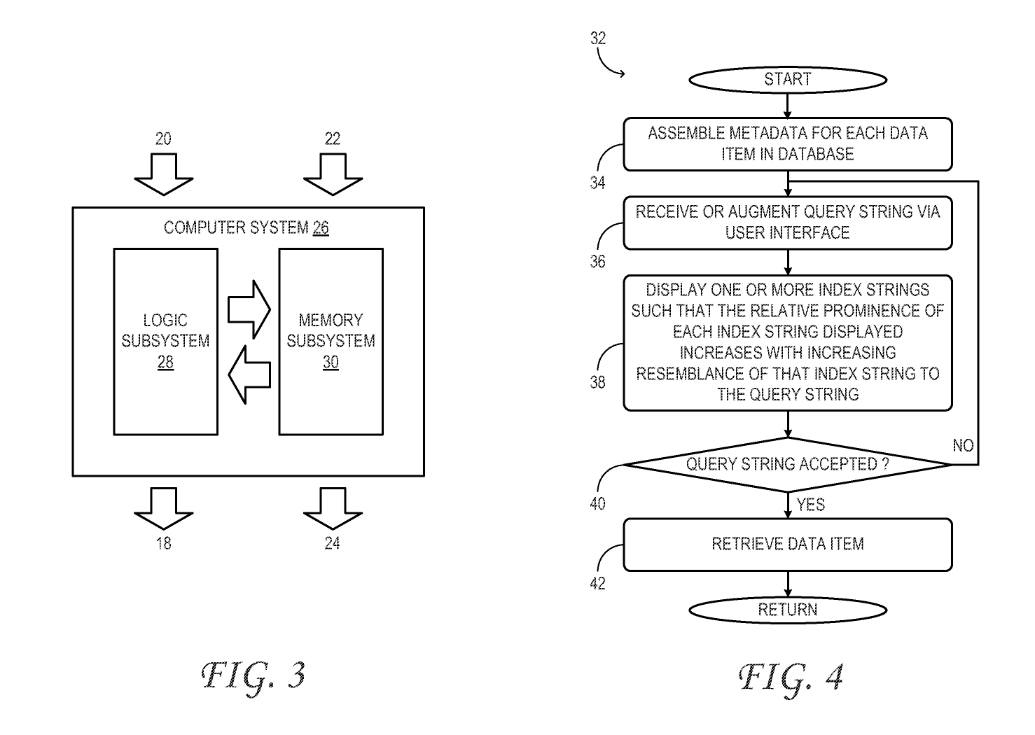

FIG. 2 also shows computer system 26 operatively coupled to the various components of user interface 16. FIG. 3 shows the computer system in greater detail. Computer system 26 includes logic subsystem 28 operatively coupled to memory subsystem 30.

Computer system 26 may be configured to enact any computation, processing, or control function of portable device 14. The computer system may be configured to receive input from keypad 20 and/or microphone 22 and to direct output to display 18 and/or loudspeaker 24. In one embodiment, the computer system may receive the electrical signal from the microphone and translate the audible speech received by the microphone into text. More specifically, the computer system may be configured to construct a query string from the translated, audible speech and use that query string in the various data-retrieval methods described hereinafter.

Aspects of data retrieval from portable device 14 will now be described with reference to an example scenario. In this scenario, the portable device is a motor-vehicle navigation system, and the user of the portable device is a motorist in Honolulu. The user is preparing to drive to 123 Kamehameha Street. If no auto-completion, auto-correction, or partial search feature were available on the portable device, the user would be obliged to enter the complete street address, which could be tedious and/or prone to error.

Suppose, however, that portable device 14 includes a database listing every street address on Oahu. If primitive auto-completion, auto-correction, or partial searching were available on the portable device, then the short query “123 KA” may result in the desired address appearing on display 18 as one of several options—e.g.,

### 123 Kamehameha Street

### 123 Kamehameha II Boulevard

### 123 Katmandu Court

Primitive auto-completion, auto-correction, and partial searching for portable devices may depend on the query string matching an index string from the database over the first N characters of the query string. However, if the query include a spelling error early in the word—e.g., “123 KHA”—such primitive methods may fail, and the desired address may not be among the options displayed. This is true no matter how many correct characters are subsequently entered. Instead of the desired address, the user will see options that match the erroneous query string over the first N characters—e.g.,

### 123 Khalid Street

### 123 Khaki Road

In view of this issue and others, primitive auto-completion, auto-correction, and partial search methods that rely on perfect agreement over the first N characters of a query string may not provide robust data retrieval.

In another scenario, portable device 14 may be configured to enact so-called “regular expression” or wildcard searching. These methods may be used to accommodate uncertainties in spelling and improve efficiency in data retrieval. However, they too are not robust and cannot remedy unexpected errors in the query string. In the above example, the query string “123 K*MEHA” would return the desired street address, but “123 KH*MEHA” would not.

In yet another scenario, portable device 14 could be configured, in principle, to enact so-called “typo-detection” or “query suggestion.” These methods are more robust and can be used to remedy unexpected errors in the query string. However, they may require connection of portable device 14 to an extensive database on a server. To function properly, the server may be configured to learn from search queries entered by multiple users. Accordingly, this approach may be difficult, slow, or costly to adapt to some data-retrieval environments.

To address the issues noted above and to secure still other advantages, the configurations here illustrated may be adapted to enable various data-retrieval methods suitable for use on a portable electronic device. As described hereinabove, one contemplated portable electronic device has a user interface and a database where a plurality of data items are indexed each to a corresponding index string. It will be understood, however, that the methods here described, and others fully within the scope of this disclosure, may be enabled via other configurations as well. The methods here described may be entered upon any time portable device 14 is operating, and may be executed repeatedly. Naturally, execution of any method may change the entry conditions for subsequent execution and thereby invoke a complex decision-making logic. Such logic is fully contemplated in this disclosure.

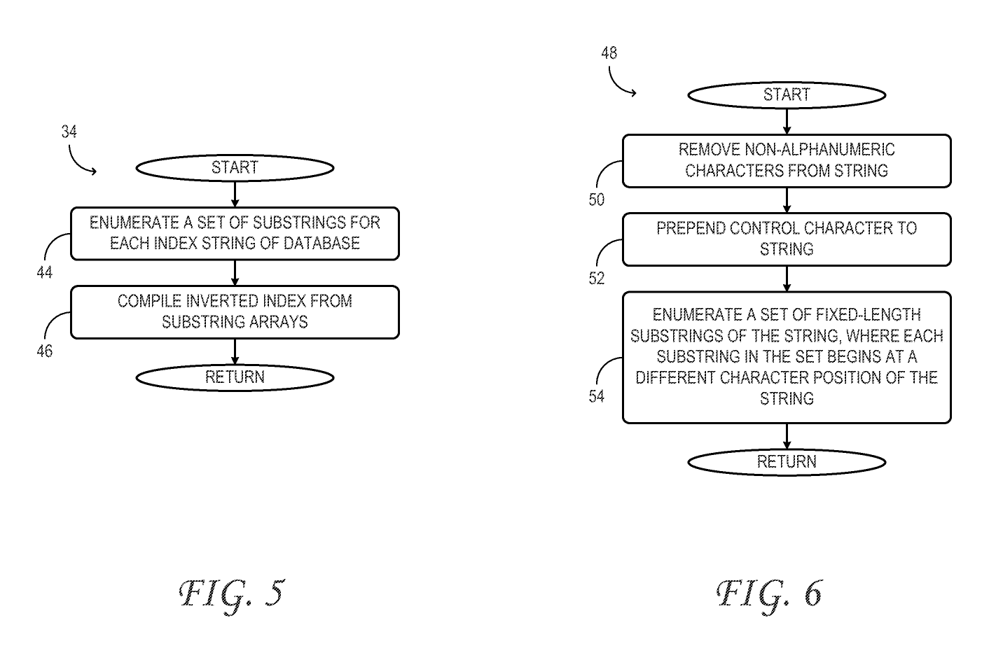

FIG. 4 illustrates an example method 32 for retrieving data from a database of a portable device. At 34, appropriate metadata is assembled for each data item in the database. In one embodiment, where the database items are indexed each to a corresponding index string, assembly of the metadata may proceed as described below in the context of FIG. 5.

At 36 a new query string is received via the user interface of the portable device, or, an existing query string is augmented via the user interface. In one embodiment, the query string may be received or augmented by typographic character entry on keypad 20. In another embodiment, the query string may be received or augmented through translation of audible speech into text, as noted above. In another embodiment, the user interface may be configured to receive handwriting as a form of input. Using a stylus, for example, the user may write an initial part of a query string on a touch-sensitive display, and the computer system may translate the user's handwriting into text.

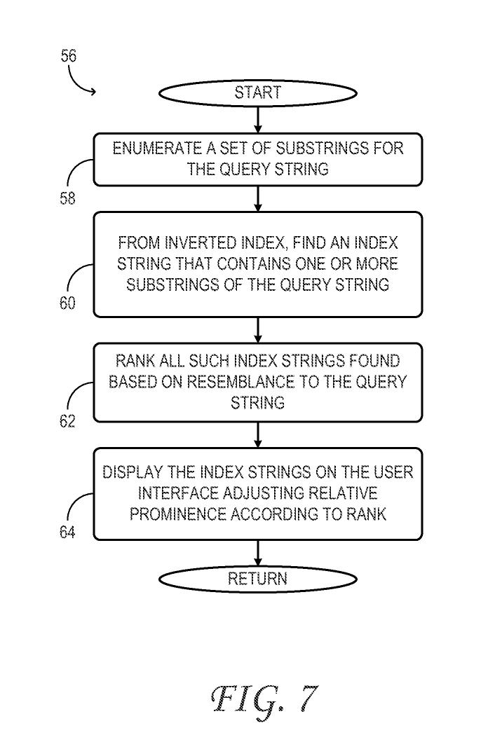

At 38 one or more index strings are displayed on the user interface such that the relative prominence of each index string displayed increases with increasing resemblance of that index string to the query string. For example, candidate index strings may be selected from the database and displayed in the form of a list. The index strings that better resemble the query string may be promoted to higher positions in the list. Likewise, the index string that most resembles the query string may be displayed in a larger or bolder typeface. In a more particular embodiment, display of the index strings may proceed as described below in the context of FIG. 7.

In these and other embodiments, the user may have the option of typing a query string in its entirely or selecting from one or more index strings chosen from the database. At 40, therefore, it is determined whether the user has accepted any query string. The user may signal acceptance of a query string, for example, by pressing the enter key on keypad 20. If the query string is not accepted, then the method returns to 36. However, if the query string is accepted, then the method advances to 42. At 42 the desired data item is retrieved from the database based on the query. The result of data retrieval will vary according to the particular embodiment being enacted. In the case of navigation, for example, matching the query string to the desired street address (e.g., a destination address) may allow the portable device to begin searching for an advisable route. In the case of media play, matching the query string to the desired song title may allow the desired song to be played. From 42, method 32 returns.

No aspect of FIG. 4 is intended to be limiting, for numerous variations and extensions are envisaged. Method 42 may be enacted as a stand-alone method, for instance, or incorporated into a more complex procedure. In one embodiment, the query string received at the user interface may be used first in a precise, partial-search algorithm, which assesses agreement between initial substrings of the query string and the index strings. The provisional result of the partial search may then be offered on the user interface. If the user makes a selection from among the candidates offered at this stage, then the method may advance directly to the data retrieval step. However, if the provisional result contain no acceptable candidate (or fail to return a candidate at all), then step 38 may be enacted.

FIG. 5 illustrates an example method 34 for assembling metadata for data items in a database, in one embodiment. This method may be invoked any time the database is altered—e.g., when one or more items are renamed, added to, or deleted from the data base. It is assumed in this example that each item stored in the database is indexed to a corresponding index string. If the database comprise a set of navigation points, for example, then the corresponding index strings may include street names or addresses. If the database comprise a music library, the corresponding index strings may include titles of songs in the library.

At 44 a set of substrings is enumerated for each index string of the database. In one embodiment, the enumerated substrings may be fixed-length substrings—e.g., two-character or three-character substrings, each beginning at a different character position of the string. In one embodiment, the set of substrings may be enumerated as described below in the context of FIG. 6.

Accordingly, if the database contain only two index strings—e.g.,

### Kahana,

### Kahuku,

then the following three-character substrings may be enumerated:

### KAH AHA HAN ANA AHU HUK UKU

At 46 an inverted index is compiled based on the set of substrings enumerated, and the method returns. The inverted index groups together all of the database entries that contain a given enumerated substring. For the example given above, a suitable inverted index based on the substrings would be:

### AHA—Kahana

### AHU—Kahuku

### ANA—Kahana

### HAN—Kahana

### HUK—Kahuku

### KAH—Kahana, Kahuku

### UKU—Kahuku

From 46, method 34 returns.

FIG. 6 illustrates an example method 48 for enumerating a set of substrings based on an index string or a query string, in one embodiment. At 50 one or more non-alphanumeric characters are removed from the string. The non-alphanumeric characters may include spaces, apostrophes, and other punctuation characters. These characters are easily forgotten or used inaccurately, making them poorly suited for distinguishing one index string from another.

In the next example, suppose that the string being processed in method 48 is an index string of a database that includes a music library. In its original form, the index string may be the complete title of a song in the library—e.g.,

### Aloha 'Oe

After 50, this index string becomes:

### AlohaOe

At 52 a control character is prepended to the string. In one embodiment, the control character may comprise a carrot symbol “̂”. This control character, or another, may be used in subsequent processing to identify (viz., to left-delimit) the starting character of the string. In some cases, the starting character of an index string (song title, street address, etc.) will be remembered particularly as being the starting character. The starting character may be especially useful, therefore, in distinguishing one index string from another.

After 52, the index string in the current example becomes:

### ̂AlohaOe

At 54 a set of fixed-length substrings of the string are enumerated. As noted above, the enumerated substrings may be fixed-length substrings—e.g., two-character or three-character substrings, each beginning at a different character position of the string. In one embodiment, where N is the length of the string, and M is the length of the fixed-length substrings, the set of substrings may include N−M+1 substrings. These substrings may begin at positions spanning the first N−M+1 characters in the string. For the current example, one possible set of enumerated substrings is:

### ̂A Al lo oh ha aO Oe

From 54, method 48 returns.

FIG. 7 illustrates, in one embodiment, an example method 56 for displaying one or more index strings on a user interface such that the relative prominence of each index string displayed increases with increasing resemblance of that index string to a query string. At 58 a set of substrings is enumerated for the query string. In one embodiment, the set of substrings may be enumerated as described above in the context of FIG. 6. At 60 an inverted index of the database is searched for one or more index strings that contain at least one substring of the query string. The inverted index may have been enumerated previously, as described above in the context of FIG. 5, for example. In this manner, those index strings of the database that include at least one substring derived from the query string may be found and enumerated.

At 62, the index strings found at 60 are ranked based on increasing resemblance to the query string. In particular, the rank of a given index string may be increased when a fixed-length substring of the query string occurs anywhere in the index string, regardless of position. However, because the starting character of the query string and of each index string are also specifically identified, the rank of an index string may also increase when a fixed-length substring of the query string starting at an initial character position of the query string occurs at an initial character position of the index string.

At this stage of the method, a suitable weighting algorithm may be used to rank the various index strings from the database. In one embodiment, a term frequency-inverse document frequency (TF-IDF) weighting approach may be used. Specifically, the rank may increase with the number of times that the fixed-length substring of the query string occurs in the index string, and decrease with the number of times that the fixed-length substring occurs in all index strings of the database. In another embodiment, a language model for information retrieval approach may be used. Other embodiments may invoke still other weighting/ranking algorithms. These algorithms help to determine how much each of the found substrings is ‘worth’ by correcting for the prevalence of the found substring in the database at large.

At 64 each of the index strings found is displayed on the user interface, with a relative prominence adjusted according to the ranking determined at 62. In one embodiment, the one or more index strings may be displayed in the form of a list with higher ranked index strings occupying higher positions on the list. In another embodiment, the highest-ranked index string may be rendered in a larger or bolder typeface. Thus, in view of the ranking described hereinabove, adjusting the relative prominence involves computing the resemblance of each of the one or more index strings to the query string and adjusting the prominence of the one or more index strings based on the resemblance computed. In this embodiment, the computed resemblance is increased with every fixed-length substring of the query string that occurs in the index string. From 64, method 56 returns.

It will be understood that some of the process steps described and/or illustrated herein may in some embodiments be omitted without departing from the scope of this disclosure. Likewise, the indicated sequence of the process steps may not always be required to achieve the intended results, but is provided for ease of illustration and description. One or more of the illustrated actions, functions, or operations may be performed repeatedly, depending on the particular strategy being used.

As noted above, the methods and functions described in this disclosure may be enacted via computer system 26, shown schematically in FIG. 3. More particularly, memory subsystem 30 may hold instructions that cause logic subsystem 28 to enact the methods. To this end, the logic subsystem may include one or more physical devices configured to execute one or more instructions. For example, the logic subsystem may be configured to execute one or more instructions that are part of one or more programs, routines, objects, components, data structures, or other logical constructs. Such instructions may be implemented to perform a task, implement a data type, transform the state of one or more devices, or otherwise arrive at a desired result. The logic subsystem may include one or more processors configured to execute software instructions. Additionally or alternatively, the logic subsystem may include one or more hardware or firmware logic machines configured to execute hardware or firmware instructions. The logic subsystem may optionally include components distributed among two or more devices, which may be remotely located in some embodiments.

Memory subsystem 30 may include one or more physical, non-transitory, devices configured to hold data and/or instructions executable by logic subsystem 28 to implement the methods and functions described herein. When such methods and functions are implemented, the state of the memory subsystem may be transformed (e.g., to hold different data). The memory subsystem may include removable media and/or built-in devices. The memory subsystem may include optical memory devices, semiconductor memory devices, and/or magnetic memory devices, among others. The memory subsystem may include devices with one or more of the following characteristics: volatile, nonvolatile, dynamic, static, read/write, read-only, random access, sequential access, location addressable, file addressable, and content addressable. In one embodiment, the logic subsystem and the memory subsystem may be integrated into one or more common devices, such as an application-specific integrated circuit (ASIC) or so-called system-on-a-chip. In another embodiment, the memory subsystem may include computer-system readable removable media, which may be used to store and/or transfer data and/or instructions executable to implement the herein-described methods and processes.

The terms “module” and “engine” may be used to describe an aspect of computer system 26 that is implemented to perform one or more particular functions. In some cases, such a module or engine may be instantiated via logic subsystem 28 executing instructions held by memory subsystem 30. It will be understood that different modules and/or engines may be instantiated from the same application, code block, object, routine, and/or function. Likewise, the same module and/or engine may be instantiated by different applications, code blocks, objects, routines, and/or functions in some cases.

Display 18 may be used to present a visual representation of data held by memory subsystem 30. As the herein-described methods and processes change the data held by the memory subsystem, and thus transform the state of the memory subsystem, the state of the display may likewise be transformed to visually represent changes in the underlying data. The display may include one or more display devices utilizing virtually any type of technology. Such display devices may be combined with logic subsystem 28 and/or memory subsystem 30 in a shared enclosure, or such display devices may be peripheral display devices.

Finally, it will be understood that the articles, systems, and methods described hereinabove are embodiments of this disclosure—non-limiting examples for which numerous variations and extensions are contemplated as well. Accordingly, this disclosure includes all novel and non-obvious combinations and sub-combinations of the articles, systems, and methods disclosed herein, as well as any and all equivalents thereof.

1. A data-retrieval method suitable for use on a portable electronic device, the device having a user interface and a database where a plurality of data items are indexed each to a corresponding index string, the method comprising:
receiving a query string at the user interface;
displaying one or more index strings on the user interface such that a relative prominence of each index string displayed increases with increasing resemblance of that index string to the query string;
displaying an index string with greater prominence when a fixed-length substring of the query string occurs anywhere in the index string, regardless of position.

2. The method of claim 1 further comprising displaying the index string with greater prominence when a fixed-length substring of the query string starting at an initial character position of the query string occurs at an initial character position of the index string.

3. The method of claim 1 further comprising removing one or more non-alphanumeric characters from the query string and from the index string.

4. The method of claim 1 further comprising prepending a control character to the query string and to the index string.

5. The method of claim 1 further comprising enumerating a set of fixed-length substrings of the query string, wherein each substring in the set begins at a different character position of the query string.

6. The method of claim 5, wherein the different character positions span the first N−M+1 characters in the query string, where N is the length of the query string, and M is the length of the substring.

7. The method of claim 5, wherein each fixed-length substring is two characters long.

8. The method of claim 5 further comprising enumerating a set of fixed-length substrings of the index string, where each substring in the set begins at a different character position of the index string.

9. The method of claim 8 further comprising, for each enumerated fixed-length substring of the query string, enumerating those index strings of the database that include that substring.

10. The method of claim 1, wherein displaying the index string with greater prominence comprises computing the resemblance of each of the one or more index strings to the query string and adjusting the prominence of the one or more index strings based on the resemblance computed.

11. The method of claim 10, wherein displaying the index string with greater prominence comprises increasing the resemblance with every fixed-length substring of the query string that occurs in the index string.

12. The method of claim 1, wherein receiving the query string comprises one or more of receiving the query string as typographic text, receiving the query string as handwritten text, and receiving the query string as speech converted to text.

13. The method of claim 1 further comprising offering on the user interface a provisional result of assessing agreement between initial substrings of the query string and the index strings, wherein said displaying is enacted when the provisional result is rejected.

14. A portable device comprising:
a user interface having a display component and an input component;
a logic subsystem operatively coupled to the display component and to the input component;
a memory subsystem operatively coupled to the logic subsystem and including instructions that cause the logic subsystem to:
receive a query string at the user interface;
display one or more index strings on the user interface, such that a relative prominence of each index string displayed increases with increasing resemblance of that index string to the query string; and
display an index string with greater prominence when a fixed-length substring of the query string occurs anywhere in the index string, regardless of position.

15. The device of claim 14, wherein the input component comprises a keypad.

16. The device of claim 15, wherein the display component comprises a touch-sensitive display, and wherein the keypad is formed on the display component.

17. The device of claim 14, wherein the input component comprises a microphone configured to receive speech, and wherein receiving the query string comprises translating the speech into text.

18. A data-retrieval system for a motor vehicle, the system comprising:
a user interface having a display component and an input component;
a logic subsystem operatively coupled to the display component and to the input component;
a memory subsystem operatively coupled to the logic subsystem, the memory subsystem including a plurality of data items and instructions that cause the logic subsystem to:
receive a query string at the user interface;
display one or more index strings on the user interface, such that a relative prominence of each index string displayed increases with increasing resemblance of that index string to the query string;
display an index string with greater prominence when a fixed-length substring of the query string occurs anywhere in the index string, regardless of position.

19. The system of claim 18 further comprising a navigation component operatively coupled to the logic subsystem, and wherein the data items include navigation data items.

20. The system of claim 18 further comprising a media play component operatively coupled to the logic subsystem, and wherein the data items include digital music.
